(19) United States
(12) Patent Application Publication
(10) Pub. No.: US 2026/0254154 A1
(43) Pub. Date: Aug. 27, 2026

(54) AUTOMOTIVE ETHERNET CONNECTOR

(71) Applicant: CHENG UEI PRECISION INDUSTRY CO., LTD., New Taipei City (TW)

(72) Inventors: HSIN-HSUN CHEN, New Taipei City (TW); SHENG-NAN YU, New Taipei City (TW)

(21) Appl. No.: 19/194,412

(22) Filed: Apr. 30, 2025

(30) Foreign Application Priority Data
Feb. 25, 2025 (CN) 202520314549.1

(51) Int. Cl. H01R 13/52; H01R 13/639; H01R 13/6581

(52) U.S. Cl. CPC H01R 13/5202; H01R 13/639; H01R 13/6581

(57) ABSTRACT

An automotive ethernet connector, comprising: an insulating housing, wherein the insulating housing is provided with a recessed mounting slot, the mounting slot is provided with an assembly hole that penetrates the insulating housing, and the assembly hole connects the inner surface of the insulating housing with the mounting slot; a connector assembly, positioned within the insulating housing, wherein the connector assembly is provided with a positioning hole, the positioning hole aligns to the assembly hole; and a locking member, fixed to the lower surface of the insulating housing, wherein the locking member is provided with a plate body positioned within the mounting slot, the upper surface of the plate body extends upward to form a positioning post fixed within the assembly hole, and the top end of the positioning post protrudes through the assembly hole and is fixed within the positioning hole.

### CROSS REFERENCE TO RELATED APPLICATIONS

The present application is based on, and claims priority from, China Patent Application No. 202520314549.1, filed Feb. 25, 2025, the disclosure of which is hereby incorporated by reference herein in its entirety.

### BACKGROUND OF THE INVENTION

### Field of the Invention

The present invention relates to an automotive ethernet connector, particularly to a waterproof and structurally stable automotive ethernet connector.

### Description of Related Art

With the rapid development of the automotive industry, various functional components and parts in automobiles are continuously advancing towards intelligence, refinement, and reliability, which also imposes higher requirements on the structural design, appearance design, and materials of automotive connectors.

China Patent No. 216598258 discloses “An Electrical Connector Assembly and Its Electrical Connector,” which includes an insulating body, a terminal assembly, and a locking member installed on the insulating body. The insulating body has a latching arm extending in a direction away from its mating end to perform a primary locking of the terminal assembly, and the locking member is assembled on the insulating body in the height direction to perform secondary locking of the terminal assembly.

However, when the insulating body and the locking member are mated, the locking force between them is insufficient, which can easily lead to the loosening of the insulating body and the locking member.

Therefore, it is necessary to provide a waterproof and structurally stable automotive ethernet connector.

### BRIEF SUMMARY OF THE INVENTION

An object of the present invention is to provide an automotive ethernet connector, comprising: an insulating housing having a mounting recess and an assembly hole, the mounting recess being formed at a bottom surface of a bottom of the insulating housing, the assembly hole being penetrated through the bottom of the insulating, the assembly hole being communicated with the mounted recess and an inside of the insulating housing; a connector assembly being positioned in the insulating housing, the connector assembly having a positioning hole located on a lower surface of the connector assembly, the positioning hole being aligned to the assembly hole; and a locking member having a plate body and a positioning post, the plate body portion being positioned within the mounting recess, the positioning post being extended from a top surface of the plate body, the positioning post being fixed in the assembly hole, a top end of the positioning post being protruded through the assembly hole and being fixed in the positioning hole.

Another object of the present invention is to provide an automotive ethernet connector, comprising: an insulating housing having a mounting recess and an assembly hole, the mounting recess being formed at a bottom surface of a bottom of the insulating housing, the assembly hole being penetrated through the bottom of the insulating, the assembly hole being communicated with the mounted recess and an inside of the insulating housing; a connector assembly being positioned in the insulating housing, an anti-retreat portion being extended from a bottom surface of the connector assembly, the anti-retreat portion being extended outward and rearward obliquely; and a locking member having a plate body and a positioning post, the plate body portion being positioned within the mounting recess, the positioning post being extended from a top surface of the plate body, the positioning post being fixed in the assembly hole, a top end of the positioning post being protruded through the assembly hole and abutted against the anti-retreat portion.

Another object of the present invention is to provide an automotive ethernet connector, comprising: an insulating housing having a mounting recess and an assembly hole, the mounting recess being formed at a bottom surface of a bottom of the insulating housing, the assembly hole being penetrated through the bottom of the insulating, the assembly hole being communicated with the mounted recess and an inside of the insulating housing; a front metal shell being positioned in the insulating housing; a rear metal shell being positioned in the insulating housing, a front of the rear metal shell enclosing a rear of the front metal shell, a position hole being formed at a bottom of the rear metal shell, the positioning hole being aligned to the assembly hole; an insulating body being positioned in the front metal shell; a plurality of terminals being positioned in the insulating body; and a locking member having a plate body and a positioning post, the plate body portion being positioned within the mounting recess, the positioning post being extended from a top surface of the plate body, the positioning post being fixed in the assembly hole, a top end of the positioning post being protruded through the assembly hole and being fixed in the positioning hole.

### BRIEF DESCRIPTION OF THE DRAWINGS

The present invention will be apparent to those skilled in the art by reading the following description, with reference to the attached drawings, in which:

FIG. 1 is a perspective view of the automotive ethernet connector of the present invention.

FIG. 2 is another perspective view of the automotive ethernet connector of the present invention.

FIG. 3 is a partially exploded view of the automotive ethernet connector of the present invention.

FIG. 4 is a schematic view of the automotive ethernet connector of the present invention.

FIG. 5 is a cross-sectional view of the automotive ethernet connector along line V-V shown in FIG. 4.

FIG. 6 is a partially exploded view of the automotive ethernet connector of the present invention.

FIG. 7 is a perspective view of the metal shell assembly of the automotive ethernet connector in the first embodiment of the present invention.

FIG. 8 is an exploded view of the metal shell assembly of the automotive ethernet connector in the first embodiment of the present invention.

FIG. 9 is a schematic view of the automotive ethernet connector of the present invention.

FIG. 10 is a cross-sectional view of the automotive ethernet connector along line X-X shown in FIG. 9.

FIG. 11 is an exploded view of the terminal assembly of the automotive ethernet connector of the present invention.

FIG. 12 is a perspective view of the wire crimp of the automotive ethernet connector of the present invention.

FIG. 13 is a perspective view of the metal shell assembly of the automotive ethernet connector in the second embodiment of the present invention.

FIG. 14 is a schematic view of the automotive ethernet connector of the present invention.

FIG. 15 is a cross-sectional view of the automotive ethernet connector along line XV-XV shown in FIG. 14.

### DETAILED DESCRIPTION OF THE INVENTION

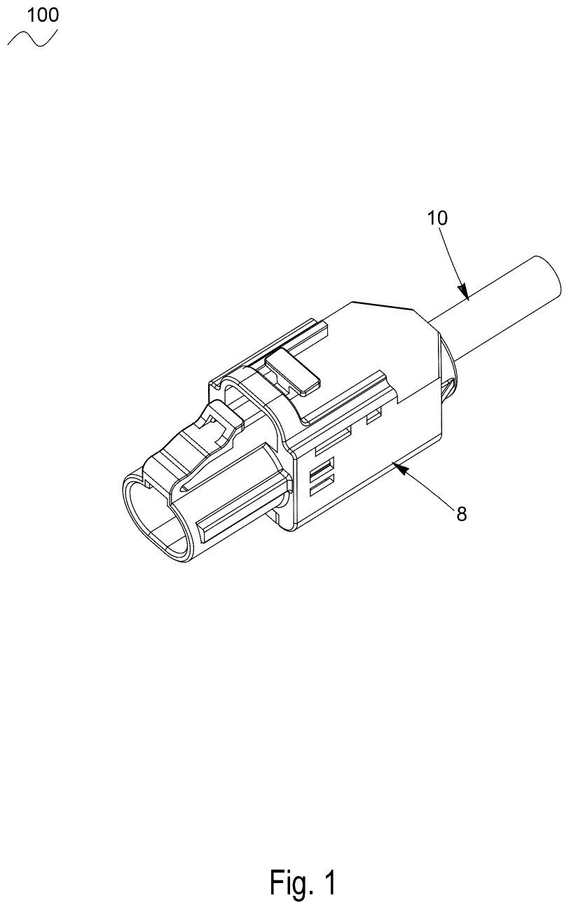

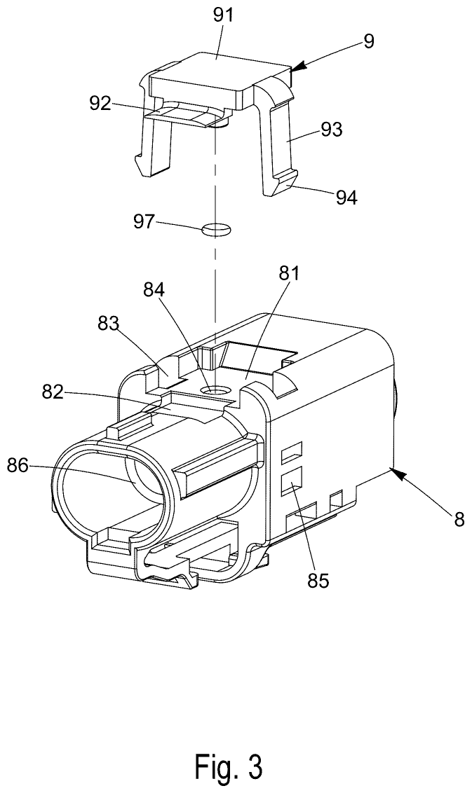

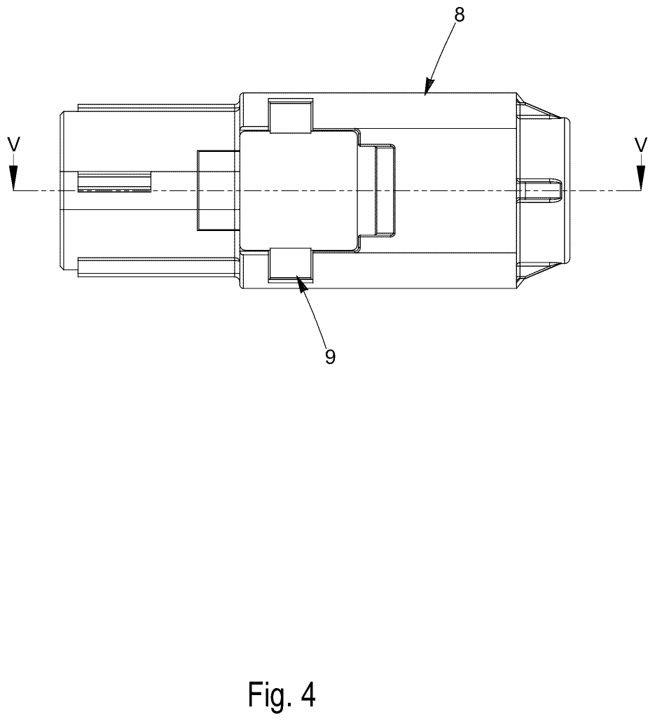

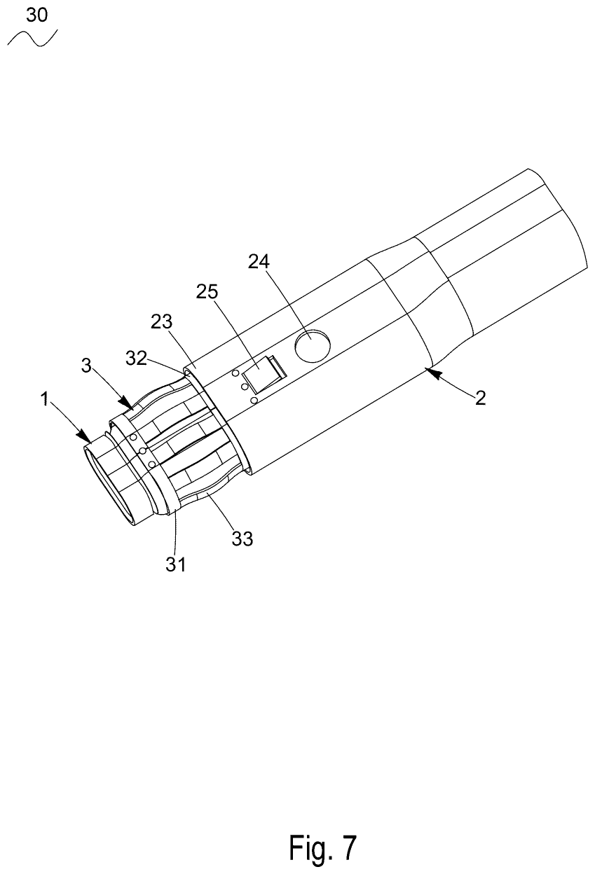

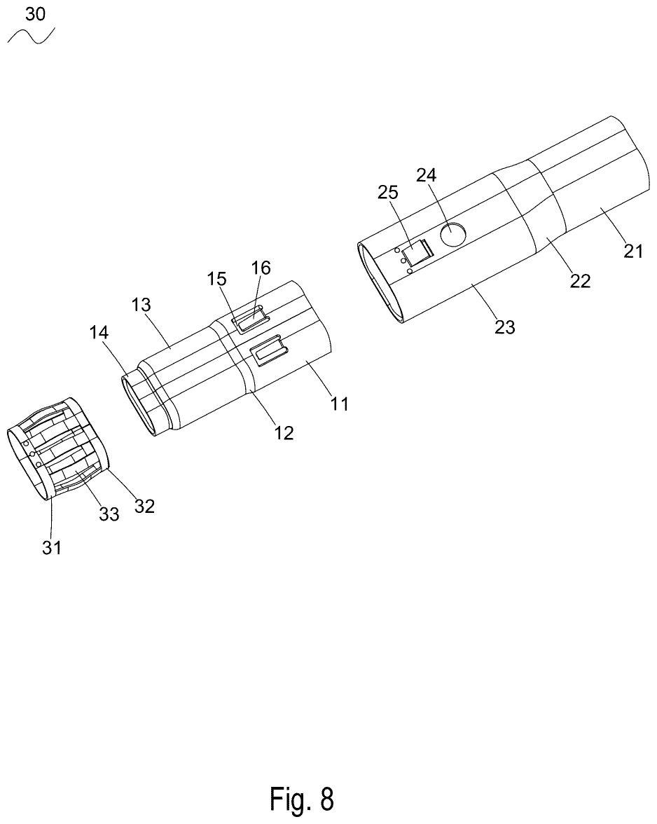

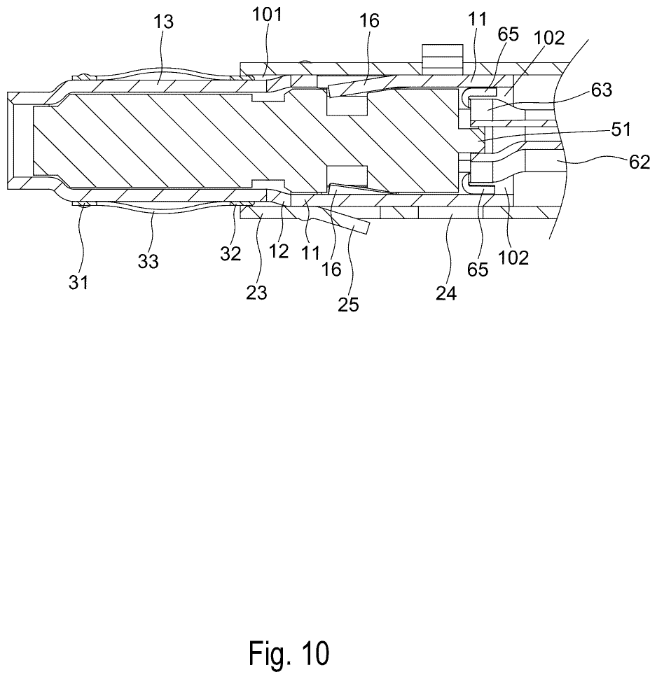

Referring to FIG. 1 to FIG. 11, the automotive ethernet connector 100 of the present invention includes a front metal shell 1, a rear metal shell 2, an elastic metal shell 3, a plurality of terminals 4, an insulating body 5, a wire crimp 6, a cable assembly 7, an insulating housing 8, and a locking member 9. The elastic metal shell 3 is sleeved around the front metal shell 1. A front of the rear metal shell 2 covers a middle and a rear of the front metal shell 1 and a rear end of the elastic metal shell 3, thus providing the automotive ethernet connector 100 with better electromagnetic interference protection and improved high-frequency signal transmission stability. The terminals 4 are disposed within the insulating body 5, which is located in the front metal shell 1. The wire crimp 6 is positioned in the rear metal shell 2 and positioned behind the insulating body 5. A front end of the wire crimp 6 contacts an inner surface of a rear of the front metal shell 1, further enhancing electromagnetic interference protection and signal transmission stability. The cable assembly 7 is secured within the wire crimp 6. The front metal shell 1, the rear metal shell 2, the elastic metal shell 3, the terminals 4, the insulating body 5, the wire crimp 6, and a part of the cable assembly 7 are housed in the insulating housing 8. The locking member 9 is fixed to a bottom surface of the insulating housing 8, and a corresponding mechanism of the locking member 9 is inserted into a corresponding mechanism of the rear metal shell 2. A top end of the corresponding mechanism of the locking member 9 abuts against an outer surface of the front metal shell 1, in order to prevent the rear metal shell 2 from moving backward, thus making the structure of the automotive ethernet connector 100 more stable. In this embodiment, the automotive ethernet connector 100 includes two terminals 4, but it is not limited to this in specific implementations. In other embodiment, the automotive ethernet connector 100 includes four terminals 4.

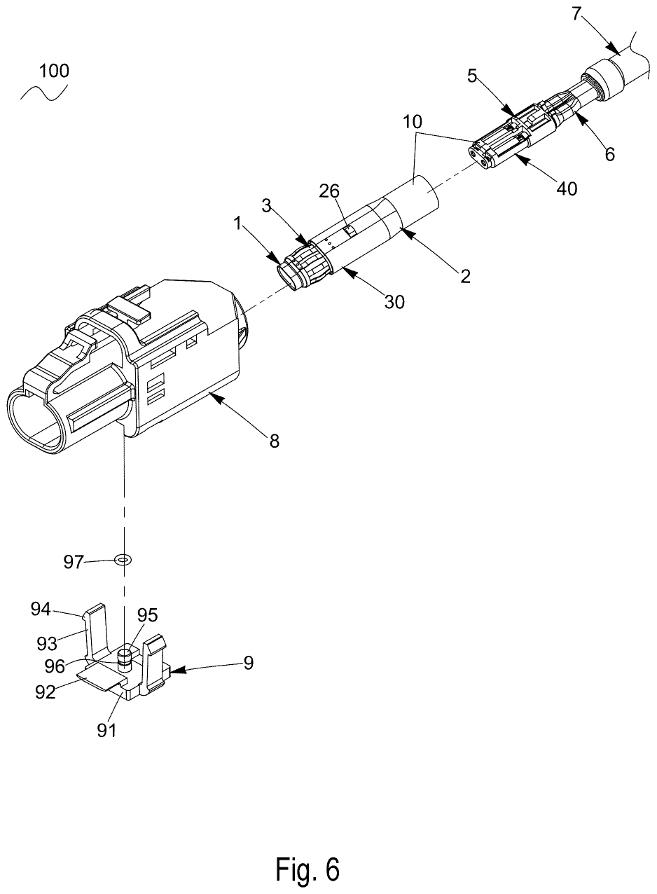

Referring to FIG. 6 to FIG. 10, the front metal shell 1 is hollow and cylindrical, and the front metal shell 1 includes a first main body portion 11, a shrink portion 12, an extension portion 13, a mating ring portion 14, a plurality of slots 15, and a plurality of first anti-retreat portions 16. The first main body portion 11 is positioned in the front of the rear metal shell 2. A front end of the first main body portion 11 extends inwardly and forwardly in an oblique manner to form the shrink portion 12, which is located in the front of the rear metal shell 2. A front end of the shrink portion 12 extends forward to form the extension portion 13, a rear end of the extension portion 13 is exposed out of the front of the rear metal shell 2. The elastic metal shell 3 is sleeved around the extension portion 13. A front end of the extension portion 13 extends inwardly and forwardly to form the mating ring portion 14.

The front metal shell 1 is provided with the slots 15 that penetrate a top wall and a bottom wall of the first main body portion 11. In the first embodiment, two the slots 15 are formed in the top wall of the first main body portion 11. A rear end of each of the slots 15 extends inwardly and forwardly in an oblique manner to form the first anti-retreat portion 16, which abuts against a corresponding mechanism of the insulating body 5 to position and secure the front metal shell 1 and the insulating body 5.

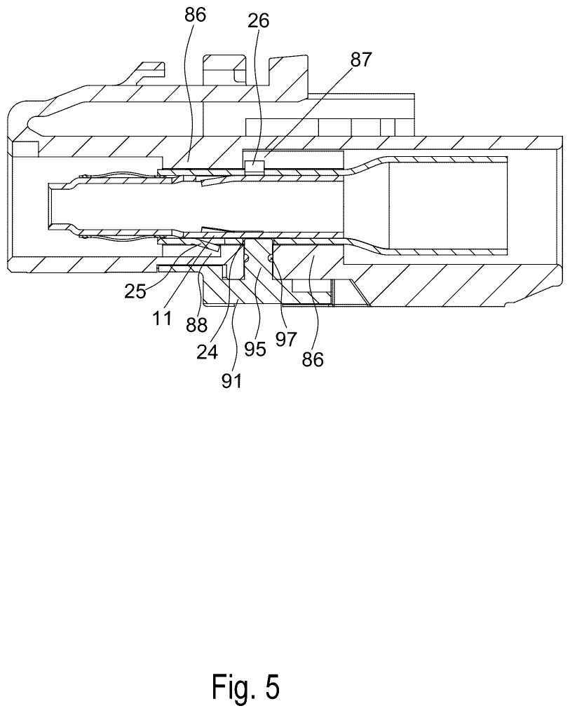

Referring to FIG. 5 to FIG. 10, the rear metal shell 2 is hollow and cylindrical, and the rear metal shell 2 includes a second main body portion 21, an expansion portion 22, a sleeve portion 23, a positioning hole 24, a second anti-retreat portion 25, and a positioning block 26. A front end of the second main body portion 21 extends outwardly and forwardly in an oblique manner to form the expansion portion 22, and a front end of the expansion portion 22 extends forward to form the sleeve portion 23. The first main body portion 11, the shrink portion 12, and the rear end of the extension portion 13 of the front metal shell 1 are all positioned in the sleeve portion 23, and the sleeve portion 23 connects with the first main body portion 11 of the front metal shell 1. In the first embodiment, the sleeve portion 23 is spot-welded to the first main body portion 11 of the front metal shell 1, but it is not limited to this in specific implementations.

The rear metal shell 2 is provided with the positioning hole 24 that penetrates the bottom wall of the sleeve portion 23. The corresponding mechanism of the locking member 9 is fixed to the positioning hole 24 to position and secure the locking member 9 and the rear metal shell 2. The top end of the corresponding mechanism of the locking member 9 abuts against an outer surface of the bottom wall of the first main body portion 11 of the front metal shell 1, in order to prevent the rear metal shell 2 from moving backward, thus making the structure of the automotive ethernet connector 100 more stable. The bottom wall of the sleeve portion 23 is provided with the second anti-retreat portion 25, which extends outwardly and backwardly in an oblique manner. The second anti-retreat portion 25 abuts against a corresponding mechanism of the insulating housing 8 to position and secure the rear metal shell 2 and the insulating housing 8. In the first embodiment, the second anti-retreat portion 25 is positioned in front of the positioning hole 24, but it is not limited to this in specific implementations. A top wall of the sleeve portion 23 extends upwardly to form the positioning block 26, which abuts against a corresponding mechanism of the insulating housing 8 to position and secure the rear metal shell 2 and the insulating housing 8. In an up-down direction, the position of the positioning block 26 aligns to the position of the positioning hole 24.

Referring to FIG. 6 to FIG. 10, the elastic metal shell 3 includes a front ring portion 31, a rear ring portion 32, and a plurality of elastic contact arms 33. In the first embodiment, the front ring portion 31 is spot-welded to the front end of the extension portion 13 of the front metal shell 1, but it is not limited to this in specific implementations. The rear ring portion 32 is aligned to the rear end of the extension portion 13 of the front metal shell 1. The rear ring portion 32 and the rear end of the extension portion 13 of the front metal shell 1 are covered by the sleeve portion 23 of the rear metal shell 2. The elastic contact arms 33 are disposed between the front ring portion 31 and the rear ring portion 32. The elastic contact arms 33 are used to mate with a corresponding mechanism of a mating connector (not shown in this figures). The elastic contact arms 33 are arranged in an insertion direction of the automotive ethernet connector 100.

More specifically, a gap 101 is formed between a front end of the sleeve portion 23 of the rear metal shell 2, the shrink portion 12 of the front metal shell 1, and the rear end of the extension portion 13 of the front metal shell 1. The rear ring portion 32 of the elastic metal shell 3 is positioned within the gap 101 and contacts an inner surface of the front end of the sleeve portion 23 of the rear metal shell 2. Simultaneously, the rear ring portion 32 of the elastic metal shell 3 contacts an outer surface of the extension portion 13 of the front metal shell 1. Therefore, the automotive ethernet connector 100 has better electromagnetic interference protection and improved high-frequency signal transmission stability.

When the automotive ethernet connector 100 is manufactured, the front metal shell 1 with the elastic metal shell 3 is accommodated in the sleeve portion 23 of the rear metal shell 2 from the front end of the sleeve portion 23 of the rear metal shell 2. Because the front ring portion 31 is fixed to the extension portion 13 of the front metal shell 1 and the rear ring portion 32 is without fixed to the extension portion 13, the rear ring portion 32 is slightly moved. Thus, the rear ring portion 32 is stably accommodated in the gap 101.

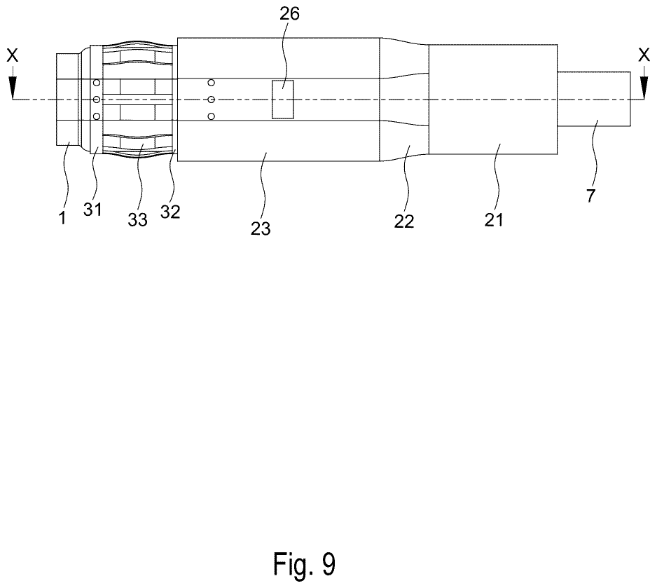

Referring to FIG. 9 to FIG. 11, the insulating body 5 is provided with a positioning protrusion 51, two grooves 52, and a blocking wall 53. A rear surface of the insulating body 5 extends backward to form the positioning protrusion 51. A corresponding mechanism of the wire crimp 6 is sleeved around the positioning protrusion 51 to position and secure the wire crimp 6 and the insulating body 5. The two grooves 52 are respectively recessed inward from an upper surface and a lower surface of the insulating body 5. The blocking wall 53 is formed in front of the two grooves 52. The first anti-retreat portions 16 of the front metal shell 1 are positioned in the two grooves 52. The first anti-retreat portions 16 of the front metal shell 1 abut against a rear surface of the blocking wall 53 to position and secure the front metal shell 1 and the insulating body 5.

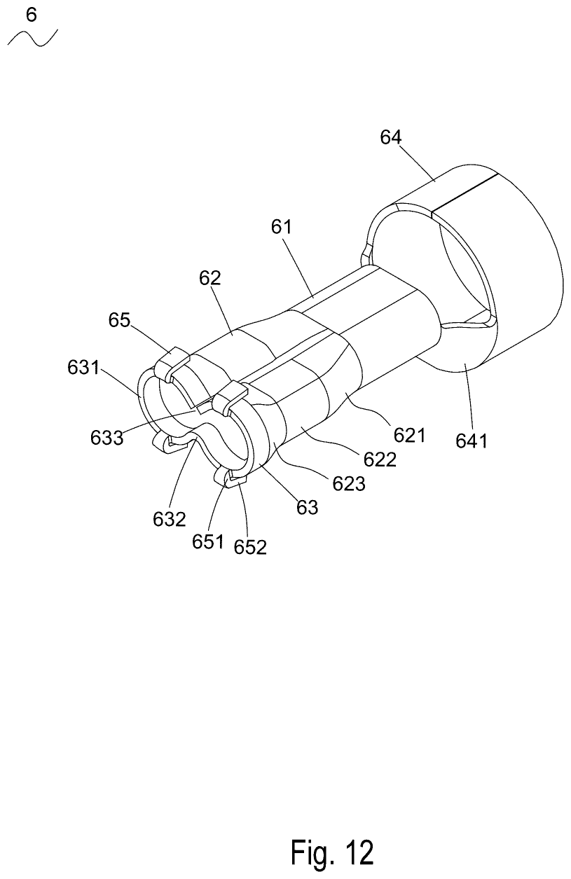

Referring to FIG. 9 to FIG. 12, the wire crimp 6 has a main portion 61, two branch portions 62, an engagement portion 63, a retaining ring 64, and a plurality of protrusions 65. A corresponding mechanism of the cable assembly 7 is positioned within the main portion 61. A front end of the main portion 61 extends forward to form the two branch portions 62. A corresponding mechanism of the cable assembly 7 is positioned within the two branch portions 62. Front ends of the two branch portions 62 extend forward to form the engagement portion 63. The engagement portion 63 is sleeved around the positioning protrusion 51 of the insulating body 5 to position and secure the wire crimp 6 and the insulating body 5. A rear end of the main portion 61 extends backward to form the retaining ring 64, which is sleeved around a corresponding mechanism of the cable assembly 7. A profile of the engagement portion 63 of the wire crimp 6 matches a profile of the positioning protrusion 51 of the insulating body 5. In this embodiment, the profile of the engagement portion 63 of the wire crimp 6 and the profile of the positioning protrusion 51 of the insulating body 5 are approximate 8-shape.

The branch portions 62 has two first outwardly expanded portions 621, two connection portions 622 and two second outwardly expanded portion 623. The front end of the main portion 61 extends forward and outward in an oblique manner to form the two first outwardly expanded portions 621. A corresponding mechanism of the cable assembly 7 is positioned within the two first outwardly expanded portions 621. Front ends of the two first outwardly expanded portions 621 extend forward to form the two connection portions 622. A corresponding mechanism of the cable assembly 7 is positioned within the two connection portions 622. Front ends of the two connection portions 622 extend forward and outward in an oblique manner to form the second outwardly expanded portion 623. Front ends of the second outwardly expanded portion 623 extend forward and outward in an oblique manner to form the engagement portion 63, which has an approximate 8-shaped cross-section.

The engagement portion 63 has a front surface 631, a bent portion 632, and a slit 633. A middle of a bottom of the engagement portion 63 bends inward to form the bent portion 632. The bent portion 632 is approximate V-shape. A middle of a top of the engagement portion 63 forms the slit 633. The slit 633 is formed in a middle of a top of the wire crimp 6. The slit 633 extends along a longitude direction of the wire crimp 6 and penetrates the front surface 631 of the engagement portion 63 and a rear surface of the main portion 61. The slit 633 is formed between tops of the two branch portions 62. The slit 633 is formed between tops of the two first outwardly expanded portions 621. The slit 633 is formed between tops of the two connection portions 622. The slit 633 is formed between tops of the two second outwardly expanded portions 623. The slit 633 is formed in a middle of a top of the engagement portion 63. The bent portion 632 is aligned to the slit 633 in the up-down direction. A rear end of the main portion 61 extends backward and outward in an oblique manner to form a connecting portion 641. The connecting portion 641 connects the rear end of the main portion 61 and a lower part of a front end of the retaining ring 64.

A top and a bottom of the front surface 631 of the engagement portion 63 has the protrusions 65. The protrusions 65 contact an inner surface of the rear of the first main body portion 11 of the front metal shell 1. More specifically, the protrusions 65 are extended forward from the front surface 631 of the engagement portion 63 and then bend backward. The protrusions 65 have a J-shaped structure. Each of the protrusions 65 has a curved portion 651 and an abutting portion 652. The curved portion 651 extends outward and backward from the front surface 631 of the engagement portion 63, and a rear end of the curved portion 651 extends backward and outward in an oblique manner to form the abutting portion 652. The abutting portion 652 abuts against the inner surface of the rear of the first main body portion 11 of the front metal shell 1. In specific implementations, the protrusions 65 can extend upward from a top surface and a bottom surface of the engagement portion 63. Therefore, the automotive ethernet connector 100 has better electromagnetic interference protection and improved high-frequency signal transmission stability. A receiving space 102 is formed between the rear of the front metal shell 1 and the positioning protrusion 51 of the insulating body 5. The engagement portion 63 and the protrusions 65 of the wire crimp 6 are positioned within the receiving space 102.

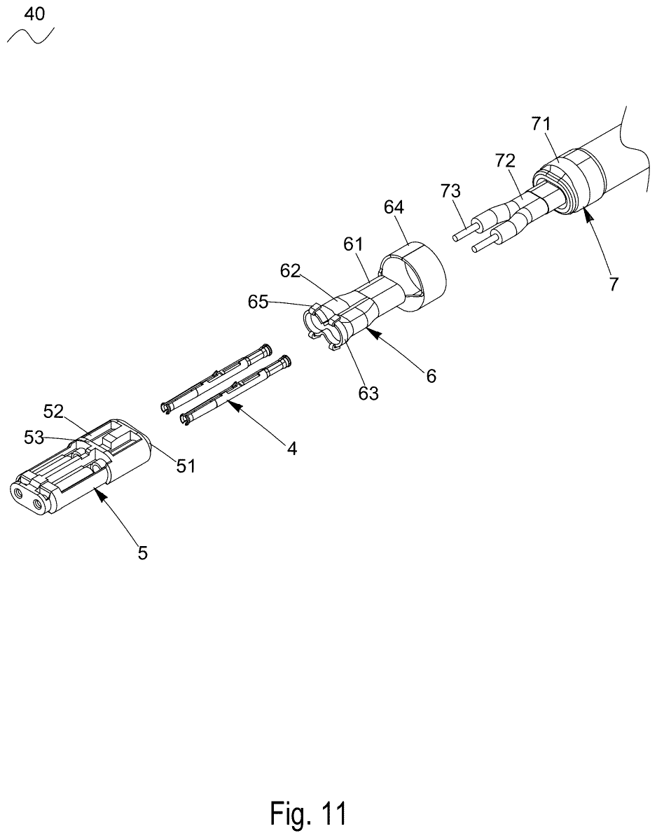

Referring to FIG. 11, the cable assembly 7 has a metal braid 71, two cables 72, and two wire cores 73. The metal braid 71 is fixed within the retaining ring 64 of the wire crimp 6. The two cables 72 are extended from a front of the metal braid 71 and the two cables 72 are parallel. The two cables 72 are fixed within the two branch portions 62 of the wire crimp 6. The two cables 72 are fixed within the two first outwardly expanded portions 621, the two connection portions 622 and the two second outwardly expanded portions 623 of the wire crimp 6. The bent portions 632 of the engagement portion 63 of the wire crimp 6 are positioned between lower surfaces of the two cables 72. The slit 633 of the wire crimp 6 is positioned between upper surfaces of the two cables 72. A front end of each cable 72 is provided with an exposed wire core 73. The wire cores 73 extend out of the engagement portion 63 of the wire crimp 6 and are crimped to rear ends of the terminals 4.

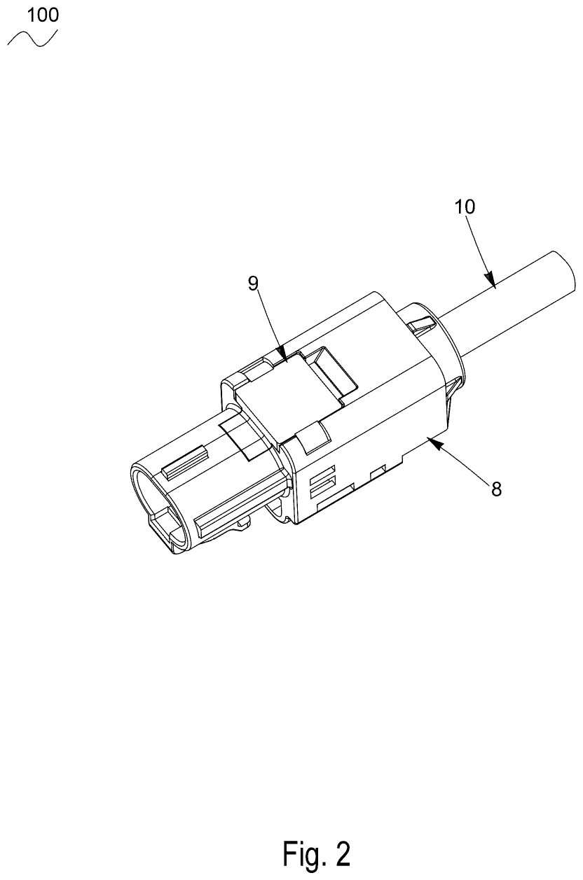

Referring to FIG. 2 to FIG. 6, the insulating housing 8 has a mounting recess 81, a concave 82, two through slots 83, an assembly hole 84, a plurality of snap holes 85, an abutting wall 86, an upper notch 87, and a lower notch 88. A middle of a bottom surface of the insulating housing 8 is recessed upward to form the mounting recess 81. The middle of the bottom surface of the insulating housing 8 is recessed upward to form the concave 82. In the first embodiment, the concave 82 is formed in front of the mounting recess 81, but it is not limited to this in specific implementations. The middle of the bottom surface of the insulating housing 8 is recessed upward to form the two through slots 83. The two through slots 83 are formed on a left side and a right side of the mounting recess 81 and the two through slots 83 communicate with the mounting recess 81. The assembly hole 84 penetrates a bottom of the insulating housing 8. The assembly hole 84 communicate with an inside of the insulating housing 8 and the mounting recess 81. The assembly hole 84 is aligned to the positioning hole 24 of the rear metal shell 2. A left side and a right side of the insulating housing 8 are recessed inward to form the snap holes 85. The snap holes 85 communicate with the two through slots 83.

The abutting wall 86 is extended inward from an inner surface of the insulating housing 8. The assembly hole 84 penetrates a bottom of the abutting wall 86. The abutting wall 86 covers the sleeve portion 23 of the rear metal shell 2 to position and secure the insulating housing 8 and the rear metal shell 2. A rear end of a top of the abutting wall 86 is recessed forward to form the upper notch 87. The positioning block 26 of the rear metal shell 2 is positioned at a front end of the upper notch 87, and the positioning block 26 of the rear metal shell 2 abuts against the abutting wall 86 of the insulting housing 8 to position and secure the rear metal shell 2 and the insulating housing 8. A front end of the bottom of the abutting wall 86 is recessed backward to form the lower notch 88. The second anti-retreat portion 25 of the rear metal shell 2 is positioned at a rear end of the lower notch 88, and the second anti-retreat portion 25 of the rear metal shell 2 abuts against the abutting wall 86 of the insulating housing 8 to position and secure the rear metal shell 2 and the insulating housing 8.

Referring to FIG. 2 to FIG. 6, the locking member 9 has a plate body 91, a front protruding portion 92, two locking arms 93, two hooks 94, a positioning post 95, a positioning groove 96, and a sealing ring 97. The plate body 91 is positioned within the mounting recess 81 of the insulating housing 8. A front end of a top surface of the plate body 91 extends upward and then forward to form the front protruding portion 92. The front protruding portion 92 is positioned within the concave 82 of the insulating housing 8 to position and secure the locking member 9 and the insulating housing 8. A left side and a right side of the plate body 91 extend upward to form the two locking arms 93. The two locking arms 93 are fixed within the two through slots 83 of the insulating housing 8. Top ends of the two locking arms 93 extend outward to form the two hooks 94. The two hooks 94 snap into the snap holes 85 of the insulating housing 8 to position and secure the locking member 9 and the insulating housing 8.

A middle of the top surface of the plate body 91 extends upward to form the positioning post 95. The positioning post 95 is fixed within the assembly hole 84 of the insulating housing 8, and a top end of the positioning post 95 protrudes through the assembly hole 84 of the insulating housing 8 and is fixed within the positioning hole 24 of the rear metal shell 2 to position and secure the locking member 9, the insulating housing 8, and the rear metal shell 2. The top end of the positioning post 95 abuts against the outer surface of the bottom wall of the first main body portion 11 of the front metal shell 1, thereby preventing the rear metal shell 2 from moving backward, thus making the structure of the automotive ethernet connector 100 more stable. A middle of the positioning post 95 is recessed inward to form the positioning groove 96, and the sealing ring 97 is positioned in the positioning groove 96 to fit tightly with the assembly hole 84 of the insulating housing 8, and thus to seal and ensure the automotive ethernet connector 100 is waterproof.

Referring to FIG. 1, FIG. 2, and FIG. 6, in this embodiment, the front metal shell 1, the rear metal shell 2, the elastic metal shell 3, the terminals 4, the insulating body 5, the wire crimp 6, and the cable assembly 7 form a connector assembly 10 together. The connector assembly 10 is assembled into the insulating housing 8 from rear to front. The front metal shell 1, the rear metal shell 2, and the elastic metal shell 3 form a metal shell assembly 30 together. The terminals 4, the insulating body 5, the wire crimp 6, and the cable assembly 7 form a terminal assembly 40 together. The terminal assembly 40 is assembled into the metal shell assembly 30 from rear to front. The terminal assembly 40 and the metal shell assembly 30 are assembled into the insulating housing 8 from rear to front.

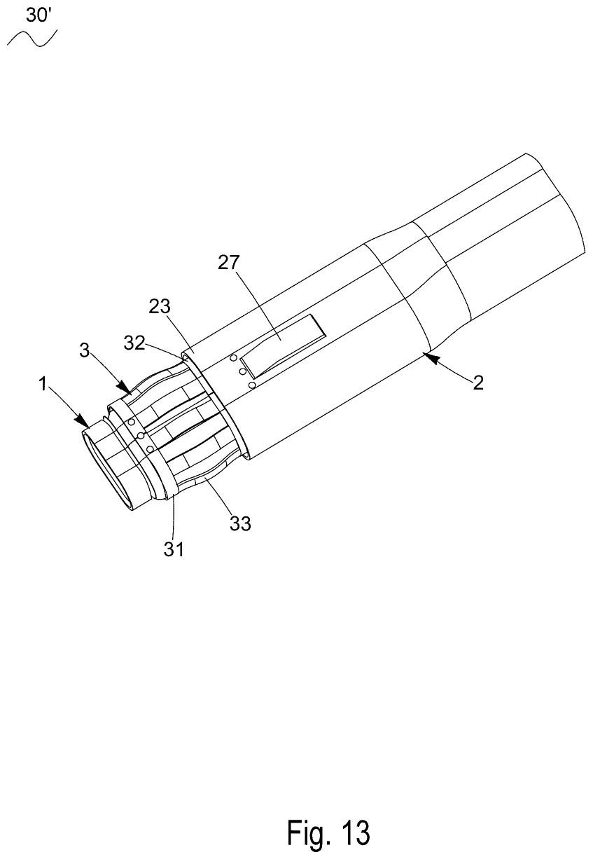

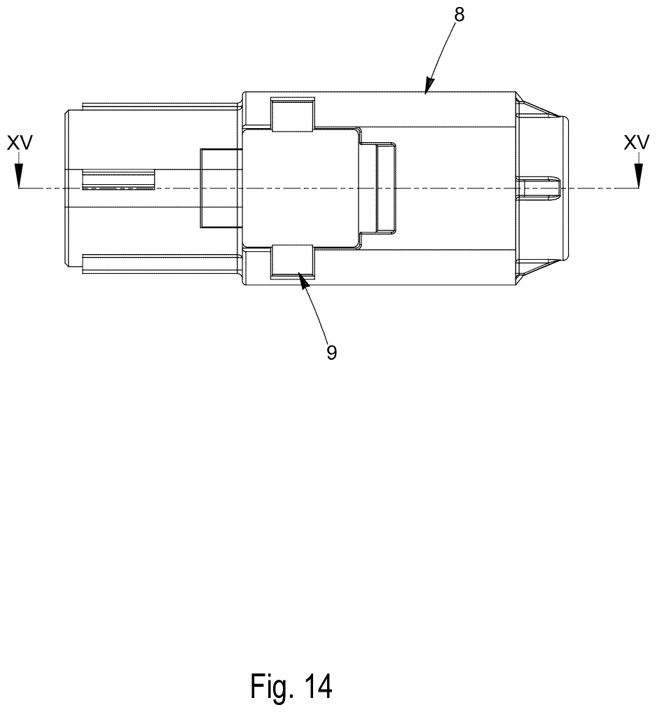

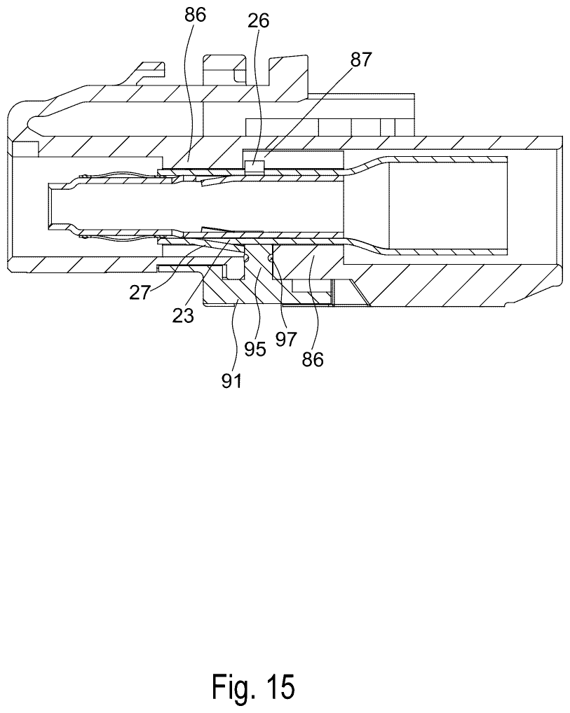

Referring to FIG. 13 to FIG. 15, which illustrate the second embodiment of the metal shell assembly 30′ of the automotive ethernet connector 100 of the present invention. The difference between the second embodiment and the first embodiment is that the metal shell assembly 30′ of the second embodiment removes the positioning hole 24. Therefore, the bottom wall of the sleeve portion 23 has a third anti-retreat portion 27 extending outward and rearward obliquely. One end of the third anti-retreat portion 27 abuts against the top end of the positioning post 95 of the locking member 9, thereby preventing the rear metal shell 2 from moving rearward, making the structure of the automotive ethernet connector 100 of the present invention more stable. The top end of the positioning post 95 of the locking member 9 abuts against the outer surface of the bottom wall of the sleeve portion 23 of the rear metal shell 2.

In summary, the automotive ethernet connector 100 in this invention includes a gap 101 formed between the front end of the sleeve portion 23 of the rear metal shell 2, the shrink portion 12 of the front metal shell 1, and the rear end of the extension portion 13 of the front metal shell 1. The rear ring portion 32 of the elastic metal shell 3 is positioned in the gap 101 and contacts the inner surface of the front end of the sleeve portion 23 of the rear metal shell 2. At the same time, the rear ring portion 32 of the elastic metal shell 3 contacts the outer surface of the extension portion 13 of the front metal shell 1. The top and the bottom of the front surface 631 of the engagement portion 63 of the wire crimp 6 has the protrusions 65. The protrusions 65 contact the inner surface of the rear of the first main body portion 11 of the front metal shell 1. The middle of the top surface of the plate body 91 of the locking member 9 extends upward to form the positioning post 95. The positioning post 95 is fixed in the assembly hole 84 of the insulating housing 8, and the top end of the positioning post 95 protrudes through the assembly hole 84 of the insulating housing 8 and is fixed in the positioning hole 24 of the rear metal shell 2 to position and secure the locking member 9, the insulating housing 8, and the rear metal shell 2. The top end of the positioning post 95 abuts against the outer surface of the bottom wall of the first main body portion 11 of the front metal shell 1, thereby preventing the rear metal shell 2 from moving rearward. The middle of the positioning post 95 is recessed inward to form the positioning groove 96, and the sealing ring 97 is positioned in the positioning groove 96. The sealing ring 97 tightly fits with the assembly hole 84 of the insulating housing 8 to ensure the automotive ethernet connector 100 is sealed and waterproof. Therefore, the automotive ethernet connector 100 of the present invention has better electromagnetic interference protection, improved high-frequency signal transmission stability, waterproofing, and a stable structure.

What is claimed is:

1. An automotive ethernet connector, comprising:
an insulating housing having a mounting recess and an assembly hole, the mounting recess being formed at a bottom surface of a bottom of the insulating housing, the assembly hole being penetrated through the bottom of the insulating, the assembly hole being communicated with the mounted recess and an inside of the insulating housing;
a connector assembly being positioned in the insulating housing, the connector assembly having a positioning hole located on a lower surface of the connector assembly, the positioning hole being aligned to the assembly hole; and
a locking member having a plate body and a positioning post, the plate body portion being positioned within the mounting recess, the positioning post being extended from a top surface of the plate body, the positioning post being fixed in the assembly hole, a top end of the positioning post being protruded through the assembly hole and being fixed in the positioning hole.

2. The automotive ethernet connector as claimed in claim 1, wherein a middle of the positioning post is recessed inward to form a positioning groove, a sealing ring is positioned in the positioning groove, the sealing ring tightly fits with the assembly hole of the insulating housing.

3. The automotive ethernet connector as claimed in claim 2, wherein an abutting wall is extended from an inner surface of the insulating housing, the assembly hole penetrates through the abutting wall and a bottom surface of the mounting recess, the abutting wall covers the connector assembly.

4. The automotive ethernet connector as claimed in claim 3, wherein a rear end of a top of the abutting wall is recessed forward to form an upper notch, a positioning block is extended from a top surface of the connector assembly, the positioning block is positioned at a front end of the upper notch, the positioning block abuts against the abutting wall.

5. The automotive ethernet connector as claimed in claim 3, wherein a front end of a bottom of the abutting wall is recessed rearward to form a lower notch, an anti-retreat portion is extended downward and rearward obliquely from a lower surface of the connector assembly, the anti-retreat portion is positioned at a rear end of the lower notch, the anti-retreat portion abuts against the abutting wall.

6. The automotive ethernet connector as claimed in claim 1, wherein the bottom surface of the insulating housing is recessed upward to form a concave, the concave is formed in front of the mounting recess and communicated with the mounting recess, a front protruding portion is extended from a front end of the top surface of the plate body and extended upward and forward, the front protruding portion is positioned in the concave.

7. The automotive ethernet connector as claimed in claim 1, wherein two locking arms are extended from a left side and a right side of the plate body, two hooks are extended outward from top ends of the two locking arms, two through slots are formed on a left side and a right side of the mounting recess, the two through slots communicate with the mounting recess, a left side and a right side of the insulating housing are recessed inward to form snap holes, the snap holes communicate with the two through slots, the two locking arms are fixed in the two through slots, the two hooks snap into the snap holes.

8. An automotive ethernet connector, comprising:
an insulating housing having a mounting recess and an assembly hole, the mounting recess being formed at a bottom surface of a bottom of the insulating housing, the assembly hole being penetrated through the bottom of the insulating, the assembly hole being communicated with the mounted recess and an inside of the insulating housing;
a connector assembly being positioned in the insulating housing, an anti-retreat portion being extended from a bottom surface of the connector assembly, the anti-retreat portion being extended outward and rearward obliquely; and
a locking member having a plate body and a positioning post, the plate body portion being positioned within the mounting recess, the positioning post being extended from a top surface of the plate body, the positioning post being fixed in the assembly hole, a top end of the positioning post being protruded through the assembly hole and abutted against the anti-retreat portion.

9. The automotive ethernet connector as claimed in claim 8, wherein the positioning post has an inwardly recessed positioning groove, a sealing ring is positioned in the positioning groove, the sealing ring closely fits with the assembly hole of the insulating housing.

10. The automotive ethernet connector as claimed in claim 8, wherein two locking arms are extended from a left side and a right side of the plate body, two hooks are extended outward from top ends of the two locking arms, two through slots are formed on a left side and a right side of the mounting recess, the two through slots communicate with the mounting recess, a left side and a right side of the insulating housing are recessed inward to form snap holes, the snap holes communicate with the two through slots, the two locking arms are fixed in the two through slots, the two hooks snap into the snap holes.

11. The automotive ethernet connector as claimed in claim 8, wherein the bottom surface of the insulating housing is recessed upward to form a concave, the concave is formed in front of the mounting recess and communicated with the mounting recess, a front protruding portion is extended from a front end of the top surface of the plate body and extended upward and forward, the front protruding portion is positioned in the concave.

12. An automotive ethernet connector, comprising:
an insulating housing having a mounting recess and an assembly hole, the mounting recess being formed at a bottom surface of a bottom of the insulating housing, the assembly hole being penetrated through the bottom of the insulating, the assembly hole being communicated with the mounted recess and an inside of the insulating housing;
a front metal shell being positioned in the insulating housing;
a rear metal shell being positioned in the insulating housing, a front of the rear metal shell enclosing a rear of the front metal shell, a position hole being formed at a bottom of the rear metal shell, the positioning hole being aligned to the assembly hole;
an insulating body being positioned in the front metal shell;
a plurality of terminals being positioned in the insulating body; and
a locking member having a plate body and a positioning post, the plate body portion being positioned within the mounting recess, the positioning post being extended from a top surface of the plate body, the positioning post being fixed in the assembly hole, a top end of the positioning post being protruded through the assembly hole and being fixed in the positioning hole.

13. The automotive ethernet connector as claimed in claim 12, the rear of the front metal shell is blocked on an inner side of the positioning hole, the top end of the positioning post is blocked by the rear of the front metal shell.

14. The automotive ethernet connector as claimed in claim 12, wherein the positioning post has an inwardly recessed positioning groove, a sealing ring is positioned in the positioning groove, the sealing ring closely fits with the assembly hole.

15. The automotive ethernet connector as claimed in claim 12, wherein an abutting wall is extended from an inner surface of the insulating housing, the assembly hole penetrates through the abutting wall and a bottom surface of the mounting recess, the abutting wall covers the rear metal shell.

16. The automotive ethernet connector as claimed in claim 15, wherein a rear end of a top of the abutting wall is recessed forward to form an upper notch, a positioning block is extended from a top surface of the rear metal shell, the positioning block is positioned at a front end of the upper notch, the positioning block abuts against the abutting wall.

17. The automotive ethernet connector as claimed in claim 15, wherein a front end of a bottom of the abutting wall is recessed rearward to form a lower notch, an anti-retreat portion is extended downward and rearward obliquely from a lower surface of the rear metal shell, the anti-retreat portion is positioned at a rear end of the lower notch, the anti-retreat portion abuts against the abutting wall.

18. The automotive ethernet connector as claimed in claim 12, wherein the bottom surface of the insulating housing is recessed upward to form a concave, the concave is formed in front of the mounting recess and communicated with the mounting recess, a front protruding portion is extended from a front end of the top surface of the plate body and extended upward and forward, the front protruding portion is positioned in the concave.

19. The automotive ethernet connector as claimed in claim 12, wherein two locking arms are extended from a left side and a right side of the plate body, two hooks are extended outward from top ends of the two locking arms, two through slots are formed on a left side and a right side of the mounting recess, the two through slots communicate with the mounting recess, a left side and a right side of the insulating housing are recessed inward to form snap holes, the snap holes communicate with the two through slots, the two locking arms are fixed in the two through slots, the two hooks snap into the snap holes.
